(19) United States
(12) Patent Application Publication
(10) Pub. No.: US 2021/0336918 A1
(43) Pub. Date: Oct. 28, 2021

(54) Voice Applications in Social Media

(71) Applicant: Padmesh Kankipati, St. Augustine, FL (US)

(72) Inventor: Padmesh Kankipati, St. Augustine, FL (US)

(73) Assignee: Padmesh Kankipati, St Augustine, FL (US)

(21) Appl. No.: 17/239,567

(22) Filed: Apr. 24, 2021

Related U.S. Application Data
(60) Provisional application No. 63/016,499, filed on Apr. 28, 2020.

(51) Int. Cl. H04L 12/58

(52) U.S. Cl. CPC H04L 51/32; H04L 51/04; H04L 51/10

(57) ABSTRACT

The instant disclosure relates to a method of social media communication utilizing voice and audio information to enable custom, curated experiences for users. In one embodiment, voice messages and responses can be accessed by selected users, only for a limited time duration. In another embodiment, live voice can be accessed by selected users, only for a predetermined time.

### FIELD OF THE INVENTION

This disclosure relates to social media platforms, specifically to use of voice content within social media platforms.

### BACKGROUND OF THE INVENTION

In today's increasingly mobile world, users are demanding the ability to access social media while engaged in other activities, including driving, biking or walking. Applications which require text input or keyboard access prevent users from accessing the application while engaged in these other activities. In addition, distracted driving has become such a serious issue that many jurisdictions have laws in place which prevent users from accessing mobile devices while driving or biking.

Also, as social media interactions become ubiquitous in our world, businesses and individuals are always in search of new ways to create customized experiences for their customers and fans. Social media platforms that allow primarily text-based interactions with only limited voice or other multimedia content limit the experience that a business or individual can provide for their customers and fans.

There exists a need for a method of using voice as a significant communication method in a social media platform. Such a method would allow users to interact with the social media platform during a variety of other activities, and also enable users to craft a customized experience which improves upon the existing text-based experience of social media.

### SUMMARY OF THE INVENTION

In particular embodiments, a method of social media communication utilizes voice and audio information to enable custom, curated experiences for users. In one embodiment, voice content can be posted and accessed by selected users, only for a limited time duration. In another embodiment, live voice can be accessed by selected users at specified times. In another embodiment, a method of a voice based social network that uses multi-media as supporting communication material only, whereas the significant communication itself is voice based.

### BRIEF DESCRIPTION OF DRAWINGS

FIG. 1 is a flowchart showing one embodiment of the disclosed method.

FIG. 2 is a flowchart showing another embodiment of the disclosed method.

FIG. 3 is a diagram of a hardware implementation capable to implement the disclosed method.

### DETAILED DESCRIPTION

The embodiments disclosed are only examples and this disclosure is not limited to these specific examples. Embodiments described in the following description may be incorporated into other systems and methods not disclosed in the following description. Structures, elements and process steps shown in the drawings are exemplary embodiments and are not to be used to limit broader teachings.

It is understood through the text of this disclosure that where elements or process steps are described as separate units, those skilled in the art will recognize that various elements or portions thereof may be integrated together. Where elements are described in the following description as integrated together into a combined element, those skilled in the art will similarly recognize that individual elements of the combination may be utilized as separate elements.

This specification includes reference to “an embodiment” or “one embodiment”. This language is intended to refer to the particular elements, structures and process steps of the embodiment being discussed in that portion of the specification. Where references are made to “an embodiment” or “one embodiment” in other portions of the specification, those similarly refer to those particular elements, structures and process steps of the embodiment being discussed in that portion of the specification. Embodiments discussed in different portions of the specification may or may not refer to the same embodiment.

The use of specific terminology in the specification is used for best describing the invention and shall not be construed as limiting. The terms “include”, “including”, “comprise” and “comprising” shall be understood to be open terminology and not limiting the listed items.

Existing social media platforms are heavily dominated by interaction via text and images. In today's mobile world, this limits the ability of users to interact with the social media platform. For example, users are unable to interact with text or image posts while driving, biking or walking. Also, text-only interactions limit the ability of users to create custom experiences on social media platforms. The disclosed invention utilizes voice as a significant communication method in a social media platform. Also voice provides a personal touch and this invention would bring such a powerful communication method to dominance in social networking.

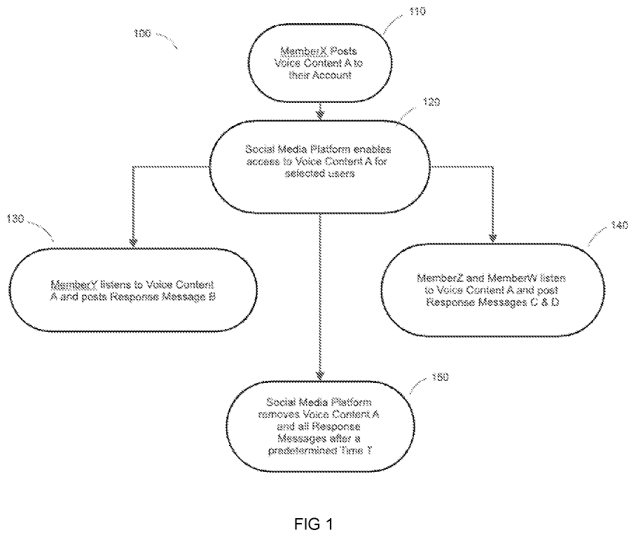

FIG. 1 shows one embodiment, a method 100 for voice-based communication on social media platforms. A user of the social media platform, named MemberX for purposes of this illustrative example, creates voice content, called Voice Content A for the purposes of this illustrative example. Voice Content A may be a recorded voice message or may be a live voice stream. In one embodiment, Voice Content A may be created on a smartphone, tablet, computer or other electronic device capable of recording or transmitting voice. In step 110, MemberX posts Voice Content A, to their social media account. The social media platform is operative to limit the amount of voice communication by members of the network. In one embodiment, the social media platform may allow the posting of a plurality of voice content by selected users of the social media platform. In one embodiment, only users with a sufficient number of followers may be allowed to post voice content. In other embodiments, the social media platform may allow the posting of voice content by all users of the social media platform. In other embodiments, users may be able to post multiple simultaneous voice content messages, and in other embodiments users may be limited to only a specified number of simultaneous voice content messages. In the specific embodiment of FIG. 1, in step 120, the social media platform enables access to Voice Content A for a selected group of users on the social media platform. The selected group of users is selected by the configuration of the social media platform, and is not dependent on invitations or other announcements to be sent from MemberX to specific other users of the social media platform. In one embodiment, the selected group of users may be all of MemberX's followers on the social media platform. In another embodiment, the selected group of users may be users who have been qualified by the social media platform to receive voice content from MemberX. In another embodiment, the selected group of users may be all users of the social media platform. In an embodiment in which the selected group of users is selected from the followers of MemberX, MemberY, MemberZ and MemberW may be other users of the social media platform included in the selected group of users, and followers of MemberX. In step 130 MemberY is enabled to post a Response Content B in response to Voice Content A. In one embodiment, Response Content B may be a converted text from the response voice message using the voice to text conversion software. In another embodiment, Response Content B may be a voice message, enabling a social media platform which relies exclusively on voice-based communication. In another embodiment, Response Content B may be live streamed voice inserted into the live stream along with Voice Content A, enabling a social media platform which relies exclusively on live voice-based communication. The size of Response Content B, either the size of a text comment response or the length of a voice message response, may be limited to control bandwidth and storage requirements. This practical limitation improves the performance of the overall social media platform by enabling implementations with smaller memory footprints and lower bandwidth requirements. In step 140, MemberZ and MemberW are each also enabled to post a response to Voice Content A. These responses are termed Response Content C and Response Content D. In one embodiment, Response Content C and Response Content D may be a converted text from the response voice message using the voice to text conversion software. In another embodiment, Response Content C and Response Content D may be voice messages, enabling a social media platform which relies exclusively on voice-based communication. In another embodiment, Response Content C and Response Content D may be live streamed voice responses inserted into the live stream along with Voice Content A, enabling a social media platform which relies exclusively on live voice-based communication. The live voice responses and the live voice stream from MemberX may be organized and made available to all followers of MemberX as a live streaming conversation, or as a recorded conversation. The sizes of Response Content C and Response Content D, either the size of a text comment response or the length of a voice message response, may be limited to control bandwidth and storage requirements. This practical limitation improves the performance of the overall social media platform by enabling implementations with smaller memory footprints and lower bandwidth requirements. In step 150, the social media platform removes Voice Content A and all responses after a predetermined time T. By removing Voice Content A and all responses after a predetermined time, the social media platform can be implemented with a smaller memory and bandwidth requirement. This practical limitation improves the performance of the overall social media platform by enabling implementations with smaller memory footprints and lower bandwidth requirements. This illustrative example uses only 4 users of the social media platform (MemberX, MemberY, MemberZ and MemberW), but one skilled in the art will appreciate that a larger or smaller number of users could similarly practice the disclosed invention.

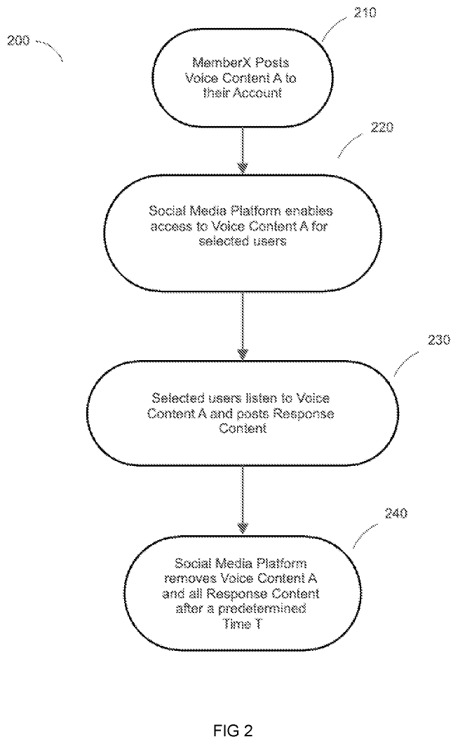

In an embodiment of the method 200, disclosed in FIG. 2, MemberX may be a prominent public figure such as a film actor. In step 210, MemberX uses an electronic device to capture Voice Content A and post Voice Content A to their account on a social media platform. In step 220 the social media platform enables access to Voice Content A for a selected group of users. In one embodiment, MemberX may create Voice Content A inviting a selected group of users to purchase tickets to a special advance screening of an upcoming film for a limited time. In another embodiment, MemberX may create Voice Content A announcing their live visit to a local theater or venue and inviting fans to a meet-and-greet session. In another embodiment, MemberX may create a live-streaming Q&A session for selected users of the social media platform. In step 230, users selected in step 220 are enabled to post Response Content related to Voice Content A. Voice Content A and Response Content may be recorded voice content or Voice Content A and Response Content may be live streaming voice as part of a live multi-party conversation. In step 240, the social media platform may remove Voice Content A and all Response Content after a predetermined time T. Optionally, the social media platform may not remove Voice Content A and Response Content and keep Voice Content A and Response Content available for interested users to access. This example is for illustrative purposes only, and the specific numbers of users and responses should not be interpreted as limiting the numbers of users and responses in any other embodiment. The disclosed method allows MemberX to create an improved experience with custom, exclusive, and time-sensitive information for selected users who listen to the voice content in the short amount of time before the social media platform removes Voice Content A and all Response Content.

In another embodiment shown in FIG. 2, MemberX may be a corporation such as a retail establishment or online seller. In step 210, MemberX uses an electronic device to capture Voice Content A and post Voice Content A to their account on a social media platform. In step 220 the social media platform enables access to Voice Content A for a selected group of users. In one embodiment, MemberX may use an electronic device to capture a message announcing a specialized offer or other exclusive information. Voice Content A may be a specialized offer which may be only active for a limited period of time, or may be only applicable to a specific geographic region. Voice Content A may be information announcing a new store opening, arrival of new products, or any other information which MemberX wishes to share with a selected group of users. In step 230, users selected in step 220 are enabled to post Response Content in the form of opinions, questions, and comments related to the offer, sale or information posted by MemberX. Voice Content A and Response Content may be recorded voice content or Voice Content A and Response Content may be live streaming voice as part of a live multi-party conversation. Response Content creates greater engagement with MemberX's content and drives greater traffic and interest in MemberX's specialized offer or exclusive information. In this manner, the disclosed method enables companies to create improved experiences for their followers and customers. At step 240, Voice Content A and Response Content may be removed from the social media platform after a predetermined time T. Optionally, the social media platform may not remove Voice Content A and Response Content and keep Voice Content A and Response Content available for interested users to access. This example is for illustrative purposes only, and the specific numbers of members and responses should not be interpreted as limiting the numbers of members and responses in any other embodiment.

In another embodiment of the method shown in FIG. 2, at step 210, MemberX may post Voice Content A comprising a topic of discussion for users of the social media platform. In step 220, a selected group of users is enabled to listen to Voice Content A. In one embodiment, the selected group of users may be all of MemberX's followers on the social media platform. In another embodiment, the selected group of users may be users that have been certified by the social media platform or by MemberX as experts in the topic of discussion. In another embodiment, the selected group of users may be all users of the social media platform. Users who receive access to Voice Content A in step 220 are enabled in step 230 to post Response Content in the form of opinions and questions related to the topic posted by MemberX. Voice Content A and Response Content may be recorded voice content, or Voice Content A and Response Content may be live streaming voice as part of a live multi-party conversation. MemberX and all users who receive access to Voice Content A may have access to Voice Content A and all responses posted by other users. At step 240, Voice Content A and Response Content may be removed from the social media platform after a predetermined time T. Optionally, the social media platform may not remove Voice Content A and Response Content and keep Voice Content A and Response Content available for interested users to access. This example is for illustrative purposes only, and the specific numbers of members and responses should not be interpreted as limiting the numbers of members and responses in any other embodiment.

In another embodiment of the method shown in FIG. 2, in step 210 MemberX may post Voice Content A comprising a question for which MemberX is seeking an answer. In step 220, a selected group of users is enabled to listen to Voice Content A. In the specific embodiment of FIG. 1, in step 120, the social media platform allows access to Voice Content A for a selected group of users on the social media platform. In one embodiment, the selected group of users may be all of MemberX's followers on the social media platform. In another embodiment, the selected group of users may be users who have been qualified by the social media platform to receive voice content from MemberX. In another embodiment, the selected group of users may be all users of the social media platform. Users who receive access to Voice Content A in step 220 are enabled in step 230 to post Response Content in the form of answers to the question posted by MemberX. Voice Content A and Response Content may be recorded voice content, or Voice Content A and Response Content may be live streaming voice as part of a live multi-party conversation regarding the question posted by MemberX. MemberX and all selected users who receive access to Voice Content A may have access to Voice Content A and all responses posted by other users. At step 240, Voice Content A and all Response Content may be removed from the social media platform after a predetermined time T. Optionally, the social media platform may not remove Voice Content A and Response Content and keep Voice Content A and Response Content available for interested users to access. This example is for illustrative purposes only, and the specific numbers of members and responses should not be interpreted as limiting the numbers of members and responses in any other embodiment.

In another embodiment of the method shown in FIG. 2, at step 210, MemberX may post Voice Content A comprising a poll or survey question for which MemberX is seeking responses. MemberX may be an individual user, a corporation or any other organization seeking to conduct a poll or survey. In step 220, a selected group of users is enabled to listen to Voice Content A. In one embodiment, the selected group of users may be the followers of MemberX. In another embodiment, the selected group of users may be users that have been certified by the social media platform or by MemberX to answer the poll or survey question. In another embodiment, the selected group of users may be all users of the social media platform. Users who receive access to Voice Content A in step 220 are enabled in step 230 to post Response Content in the form of responses to the poll or survey question posted by MemberX. Voice Content A and Response Content may be recorded voice content, or Voice Content A and Response Content may be live streaming voice as part of a live multi-party conversation regarding the poll or survey question posted by MemberX. MemberX and all users who receive access to Voice Content A may have access to Voice Content A and all Response Content posted by other users. In this manner, the disclosed method enables users of the social media platform to conduct poll questions or surveys of a selected group of users of the social media platform. A corporation may use the disclosed method to conduct surveys of their employees, or their customers. At step 240, Voice Content A and all Response Content may be removed from the social media platform after a predetermined time T. Optionally, the social media platform may not remove Voice Content A and Response Content and keep Voice Content A and Response Content available for interested users to access. This example is for illustrative purposes only, and the specific numbers of members and responses should not be interpreted as limiting the numbers of members and responses in any other embodiment.

In another embodiment of the method shown in FIG. 2, at step 210, MemberX may post Voice Content A comprising news information of interest to users of the social media platform. MemberX may be an individual user, a media outlet or any other organization seeking to communicate news information. In step 220, a selected group of users is enabled to listen to Voice Content A. In one embodiment, the selected group of users may be all of MemberX's followers on the social media platform. In another embodiment, the selected group of users may be users who have been qualified by the social media platform to receive voice content from MemberX. In another embodiment, the selected group of users may be all users of the social media platform. Selected users who receive access to Voice Content A in step 220 are enabled in step 230 to post Response Content in the form of responses to the news information posted by MemberX. Voice Content A and Response Content may be recorded voice content, or Voice Content A and Response Content may be live streaming voice as part of a live multi-party conversation regarding the new information posted by MemberX. MemberX and all users who receive access to Voice Content A may have access to Voice Content A and all Response Content posted by other users. In this manner, the disclosed method enables users to conduct a voice-based conversation regarding any news information posted on the social media platform. At step 240, Voice Content A and all Response Content may be removed from the social media platform after a predetermined time T. Optionally, the social media platform may not remove Voice Content A and Response Content and keep Voice Content A and Response Content available for interested users to access. This example is for illustrative purposes only, and the specific numbers of members and responses should not be interpreted as limiting the numbers of members and responses in any other embodiment.

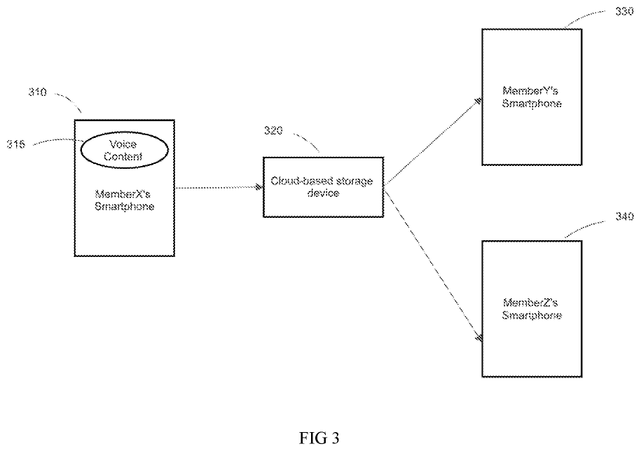

FIG. 3 shows a hardware implementation capable to implement the disclosed method. MemberX's smartphone 310 may capture or stream Voice Content 315. Voice Content 315 may be transmitted to a non-transitory computer-readable Cloud Storage Device 320. The social media platform may transmit Voice Content 315 from non-transitory computer-readable Cloud Storage Device 320 to selected individual users who may be followers of MemberX. In another embodiment, the social media platform may transmit Voice Content 315 from non-transitory computer-readable Cloud Storage Device 320 to individual users selected in another manner. In the example shown in FIG. 3, non-transitory computer-readable Cloud Storage Device 320 may send Voice Content 315 to MemberY's smartphone 330 and MemberZ's smartphone 340. Cloud Based Storage Device 320 may remove Voice Content 315 after a predetermined time T. Removing Voice Content after a predetermined time reduces the storage requirements of the social media platform and enables the platform to operate more efficiently with a smaller memory footprint. In this embodiment, the social media platform transmits Voice Content 315 to followers of MemberX, but in another embodiment, the social media platform may transmit Voice Content 315 to a group of users who have affirmatively selected to receive content from MemberX, or to a group of users selected in another manner.

The embodiments described herein are intended to be exemplary only, and it will be known to those skilled in the art that various modifications and variations can be made in the disclosed processes without departing from the scope of the disclosed method. For example, the numbers of users may be more or fewer than the numbers used in the preceding examples. Other embodiments will be apparent to those skilled in the art from consideration of the specification and practice of the method disclosed herein. The invention can be used for another application not mentioned here. As an example, A live voice auction where participants' beyond the boundaries of a region can participate and actively voice bid. The invention is not tied to any particular application examples discussed here.

I claim:

1. A method of voice communication over a social media platform, comprising the steps of:
capturing voice content from a user of said social media platform;
enabling access to said voice content for a selected group of other users of said social media platform;
receiving a plurality of responses to said voice content from said selected group of other users;
providing access to all said responses to said selected group of other users; and
removing access to said voice content and all said responses after a predetermined time.

2. The method of claim 1, wherein said selected group of other users is a collection of followers of said user on said social media platform.

3. The method of claim 1, wherein said selected group of other users is a set of users qualified by said social media platform.

4. The method of claim 1, wherein said selected group of other users is all users of said social media platform.

5. The method of claim 2, 3 or 4, wherein said voice content is a live voice stream.

6. The method of claim 5, wherein said voice content is a topic of discussion between said user and said selected group of other users.

7. The method of claim 6, wherein said plurality of responses are live voice responses from individual members of said selected group of other users.

8. The method of claim 7, wherein said live voice content and live voice responses are organized into a live streaming conversation.

10. The method of claim 2, 3 or 4, wherein said voice content is a recorded voice message.

11. The method of claim 10, wherein said plurality of responses are recorded voice responses from individual members of said selected group of other users.

12. The method of claim 1, wherein said access is removed after a duration of less than or equal to 2 minutes.

13. The method of claim 1, wherein said access is removed after a duration of more than 2 minutes.
